(19) United States
(12) Patent Application Publication
(10) Pub. No.: US 2011/0313985 A1
(43) Pub. Date: Dec. 22, 2011

(54) User adjustable ranking and presentation of search results

(76) Inventor: Jianwei Dian, Plano, TX (US)

(21) Appl. No.: 13/134,889

(22) Filed: Jun. 20, 2011

Related U.S. Application Data
(60) Provisional application No. 61/398,144, filed on Jun. 21, 2010.

(51) Int. Cl. G06F 17/30

(52) U.S. Cl. 707/706; 707/E17.108; 707/E17.008

(57) ABSTRACT

Method and system for enabling a user of a query based search engine to have some control over the presentation of search results. In some embodiments, the method and system provides an associating interface for a user of a query based search engine to associate documents with a search query, with the documents being termed as associated documents. The method and system stores the associated documents. The method and system causes the associated documents to be presented in a special area.

### CROSS-REFERENCE TO RELATED APPLICATIONS

This application is based on and claims the benefit of U.S. provisional patent application, application No. 61/398,144, filed Jun. 21, 2010, entitled “USER ADJUSTABLE RANKING AND PRESENTATION OF SEARCH RESULTS”, the content of which is hereby incorporated by reference in its entirety.

### FEDERALLY SPONSORED RESEARCH OR DEVELOPMENT

Not Applicable

### SEQUENCE LISTING OR PROGRAM

Not Applicable

### NOMENCLATURE

In this disclosure, with respect to nomenclature, in addition to considering the context of how the terms are used, for the avoidance of doubt, the following terms are explained:

“Interface”—The term “interface” refers to the places and means by which a user of a product uses the product or interacts/communicates with the product. It's also called “user interface”.

“Document”—The term “document” refers to a digital file that contains information useful in some sense and is stored in some format. For example, a document can be in HTML format, Microsoft Word format, PDF format, JPEG format, or another format.

“URL”—The term “URL” stands for “Universal Resource Locator”, which is the unique address of a document (such as a web page) on the World Wide Web.

“Search engine”—The term “search engine” refers to an information retrieval system designed to help find particular information. Search engines help to minimize the time required to find information and the amount of information which must be consulted, akin to other techniques for managing information overload.

The most visible and popular search engines are web search engines that search for information on the World Wide Web. The most popular web search engine is Google. In the case of a web search engine, a “document” may be a web page, a PDF file, an image, a video clip, or another type of files available on the World Wide Web.

“Search query”—The term “search query” refers to a query that a user enters into a search engine to request information the user needs.

“Query based search engine”—The term “query based search engine” refers to a search engine that provides a search query interface. A user of the search engine can enter a search query through the search query interface. The search engine checks into the relevant database (such as the World Wide Web) to find documents that match the user's search query according to some criteria, with those documents being termed as matched documents. Finally, the search engine presents the matched documents to the user in some forms. The “matched documents” may contain only a single document when there is only one matched document. In this disclosure, the term “matched documents” should be interpreted in this way. The matched documents are also called “search results”.

Query based web search engines are the most popular query based search engines, and they are search engines that search for information on the World Wide Web.

### BACKGROUND OF THE INVENTION

A. Field of the Invention

The present invention generally relates to query based search engines, and specifically relates to how to enable a user of a query based search engine to have some control over the ranking and presentation of search results.

B. Related Art of the Invention

Query based web search engines are the most popular query based search engines, and they are also representative of query based search engines. Thus, from time to time in this disclosure, query based web search engines are used as an embodiment of query based search engines in the descriptions and explanations of the present invention. This is for the sake of illustrations and explanations. It should not be construed as limiting the scope of the present invention.

Google is the most popular query based web search engine, and it's also representative of query based web search engines. Thus, Google is used as an embodiment of query based web search engines when the differences between current query based search engines and the present invention are described, and when the disadvantages of current query based search engines and the advantages of the present invention are described. This is for the sake of illustrations and explanations. It should not be construed as limiting the scope of the present invention.

Below is how Google works:

Google provides a search query interface which has an input box for a user to type in a search query. After Google receives the search query from the user, Google checks into its database of all indexed documents to identify the documents (matched documents) that match the user's search query according to certain criteria set by Google. Finally, Google presents the matched documents to the user according to the matched documents' rankings determined by Google. To be specific about the presentation of the matched documents, Google presents the list of the matched documents from the top to the bottom with the rankings of the matched documents from the highest to the lowest.

When Google presents a matched document, Google displays a title of the matched document, which is a hyperlink of the document. If the user clicks on the hyperlink, then the user will be redirected to the document, whether a web page, or a PDF file, or some other types of files. Below the title of the document, Google displays some excerpted texts from the document. For an example, for the search query “Jianwei Dian”, below is the Google's display of the first matched document in the list of matched documents:

Jianwei Dian's Personal Homepage

Jianwei Dian's Personal Homepage. A few universities in China: Sichuan University•North China Institute of Water Conservancy and Electric Power . . .

. . .

In the Google's display, “Jianwei Dian's Personal Homepage” is the title that Google determined for the document, and the title is a hyperlink. If the user clicks on the title, the document, which is a web page, will load.

After Google presents the matched documents to the user, normally, the user will examine the documents (by either looking at the contents that Google presents or by actually navigating into the documents) to see which documents (or document) most likely contain what the user is looking for. The fewer documents that the user needs to examine the less time that the user needs to spend to find what the user is looking for. Thus, it is good if one (or more) of the first few matched documents at the top contains the information that the user is looking for. However, a lot of times, the matched documents at the top don't contain the information that the user is looking for, and the user needs to examine many documents to find documents (or, document) that contain what the user is looking for. Sometimes, the user needs to go deep into the list of the matched documents to find the documents (or document) that contain what the user is looking for.

In considering the above situation, Google has a disadvantage. For a search query, a user may need to dive deep into the list of matched documents to find the documents (or document) that contain what the user is looking for. Later on at a different time, when the user performs a search with the same search query, the user may need to spend time to go through the same process again to find the documents (or document) that contain what the user is looking for, since the user may already forget which documents (or document) contain the information the user needs. The repeated examinations of the matched documents waste the user's time. This is a disadvantage of Google.

C. Objects and Advantages of the Invention

For current query based search engines, a user does not have control over the ranking or presentation of matched documents, such as the order in which the matched documents are presented. The search engines fully control the ranking and presentation of the matched documents.

The present invention provides method and system for a user of a query based search engine to have some control over the ranking and presentation of the matched documents. With the present invention, after performing a search with a search query and finding the documents (or, document), with the documents being termed as the user's “desired documents”, that contain what the user is looking for, the user can associate the user's desired documents with the search query so that the user's desired documents will be presented in a special area when the user performs a search with the same search query later on. For examples, the user's desired documents may be presented in a separate area above the list of matched documents that the search engine presents to the user, or the user's desired documents may be presented at the top of the list of matched documents that the search engine presents to the user. Because of the presentation of the user's desired documents in the special area, the user can easily sight the user's desired documents. (The “desired documents” may contain only a single document when the user only finds one desired document. In this disclosure, the term “desired documents” should be interpreted in this way.)

One of the advantages of the present invention is: For a search query, after a user finds the user's desired documents and associates the documents with the search query, when the user performs a search with the same search query later on, the user does not need to re-examine any (or many) documents, since the user's desired documents are presented in the special area so that the user can easily sight the user's desired documents. This saves the user's time.

Further objects and advantages of the present invention will become apparent from a consideration of the drawings and ensuing descriptions.

### SUMMARY

Method and system for enabling a user of a query based search engine to have some control over the ranking and presentation of search results. In some embodiments, the method and system provides an associating interface for a user of a query based search engine to associate documents with a search query, with the documents being termed as associated documents. The method and system stores the associated documents. The method and system causes the associated documents to be presented in a special area.

### DRAWINGS

FIG. 1 shows a flow chart of the preferred embodiment.

FIG. 2 shows an associating interface in the case that the clickable buttons are displayed after the titles of the matched documents.

FIG. 3 shows an associating interface in the case that the clickable buttons are displayed before the titles of the matched documents.

FIG. 4 shows an associating interface in the case of an input box.

FIG. 5 shows an associating interface in the case of containing both clickable buttons and an input box.

FIG. 6 shows an on-off switch for the associating interface.

FIG. 7 shows a disassociating interface in the case that the clickable buttons are displayed after the titles of the associated documents.

FIG. 8 shows a disassociating interface in the case that the clickable buttons are displayed before the titles of the associated documents.

FIG. 9 shows a flow chart of the process that the document saver performs when a user associates a document with a search query.

FIG. 10 shows a flow chart of the process that the document saver performs when a user disassociates a document from a search query.

FIG. 11 shows an example of presenting the list of the associated documents in a separate area above the list of matched documents.

FIG. 12 shows an example of presenting the list of the associated documents at the top of the list of matched documents that the search engine presents to the user.

FIG. 13 shows a flow chart of the process that the presenter performs for presenting the list of the associated documents in the special area.

FIG. 14 shows a flow chart of the process that the presenter performs when a user associates a document with a search query.

FIG. 15 shows a flow chart of the process that the presenter performs when a user disassociates a document from a search query.

FIG. 16 shows a flow chart of the process that the ranker performs for ranking the associated documents in a special way.

### DETAILED DESCRIPTION

The present invention provides computer-based method and system for a user of a query based search engine to have some control over the ranking and presentation of search results. The system is a system that performs the method. Thus, all descriptions apply to both the method and the system regardless of whether the descriptions are made in the context of the method or in the context of the system.

Details of the present invention will be described with the following sections: A. Preferred Embodiment; B. More Variations; and C. Conclusions, Ramifications and Scope of the Present Invention.

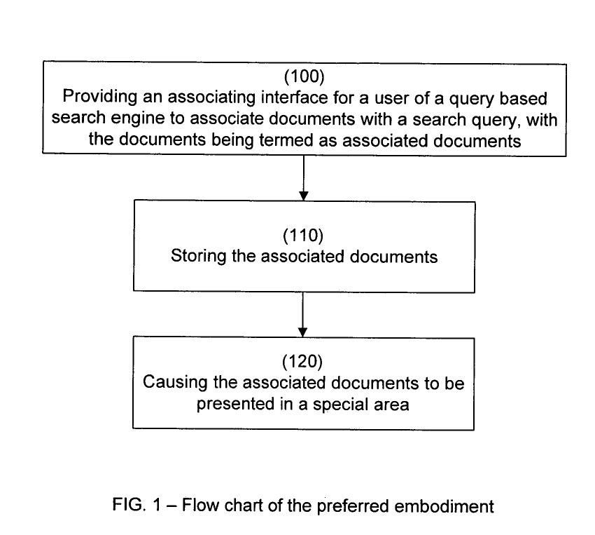

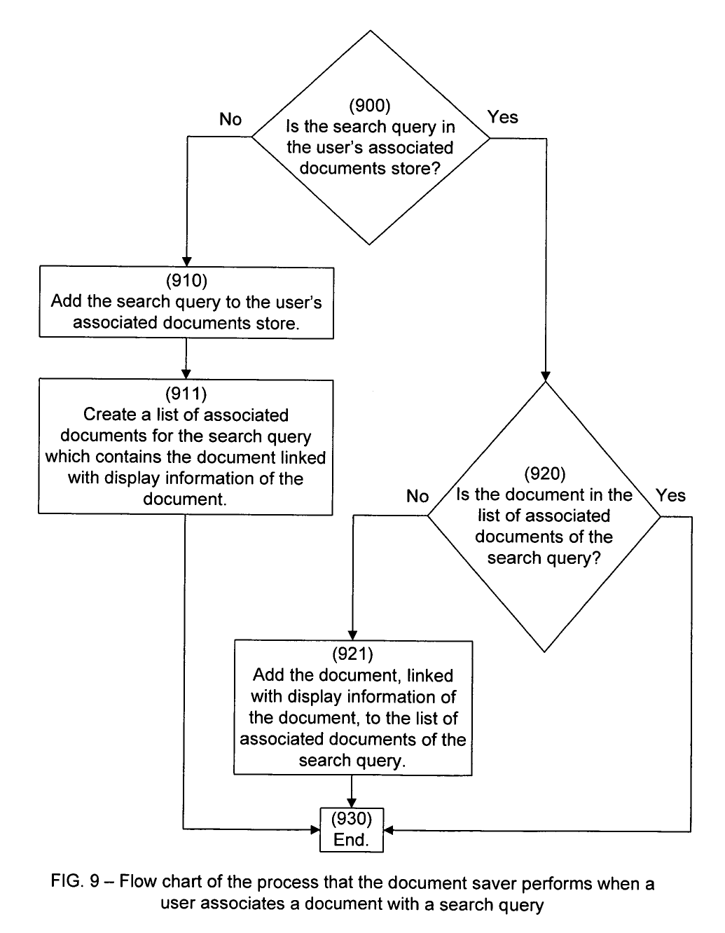

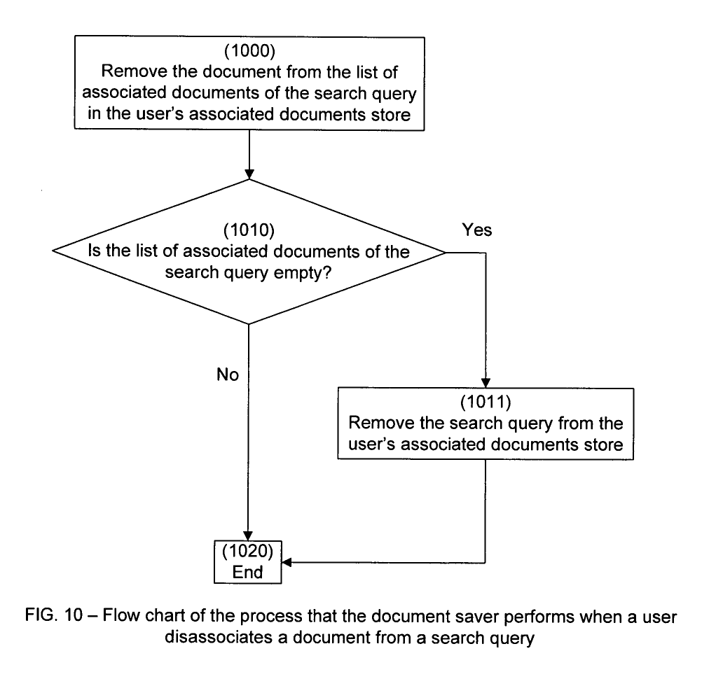

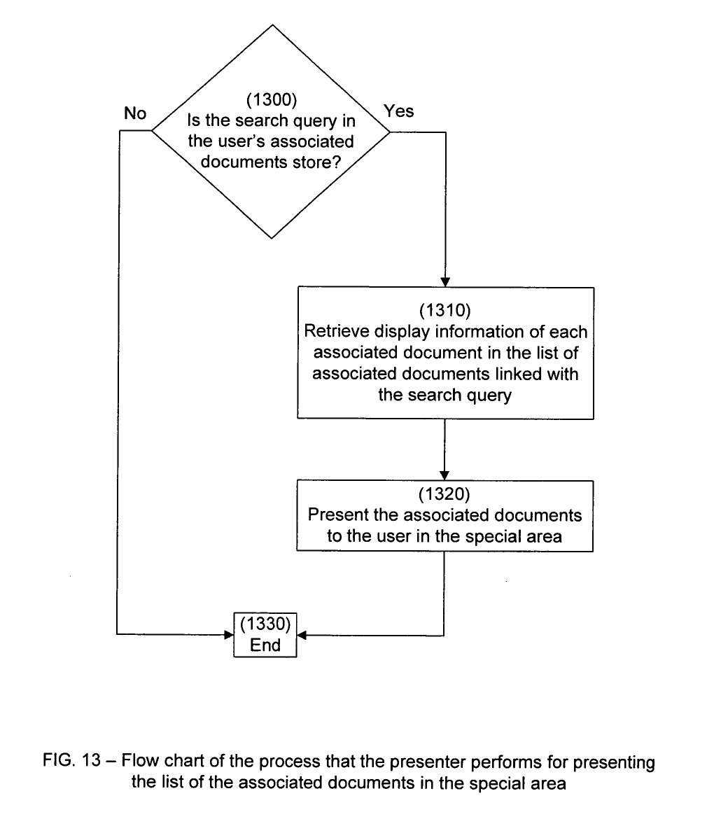

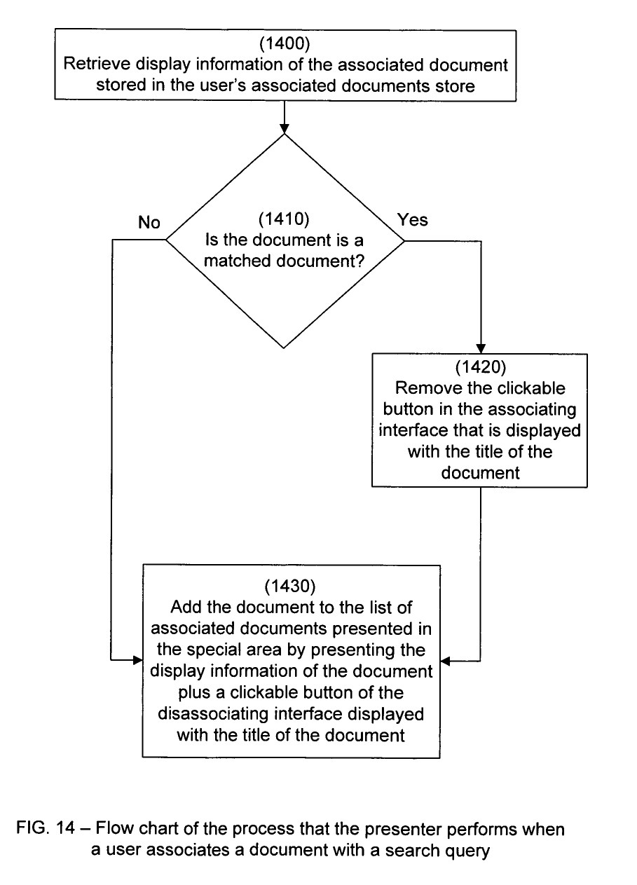

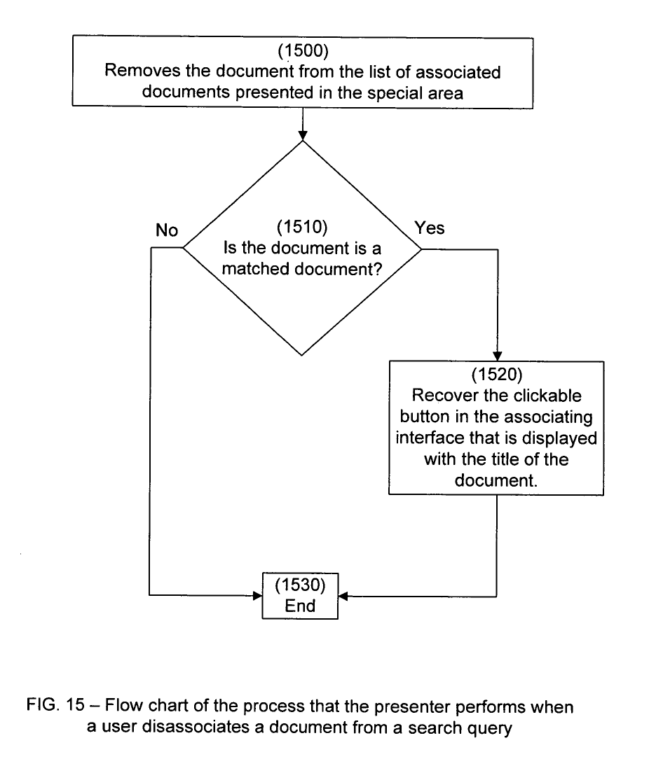

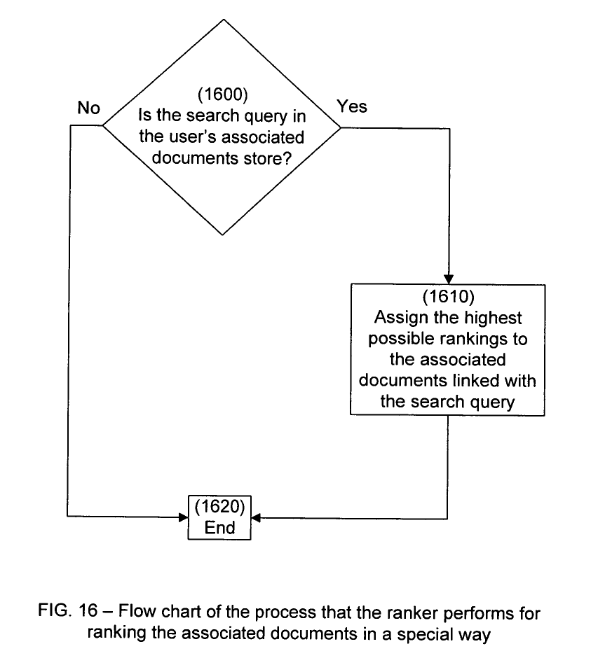

FIG. 1, FIG. 9, FIG. 10, FIG. 13, FIG. 14, FIG. 15 and FIG. 16 are block diagrams that show various flow charts. The steps in the flow charts are implemented through some programming language. The program code can be stored on a computer-readable storage medium. When executed, the program code will cause a computer to perform the steps in the flow charts.

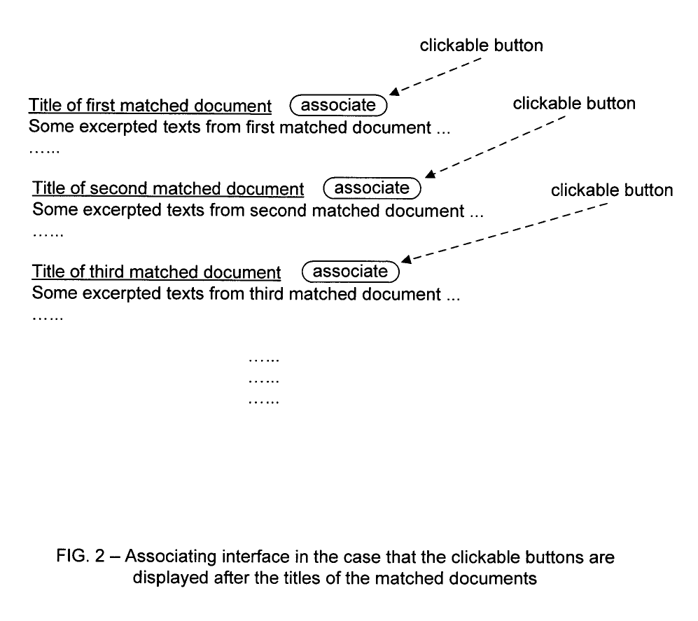

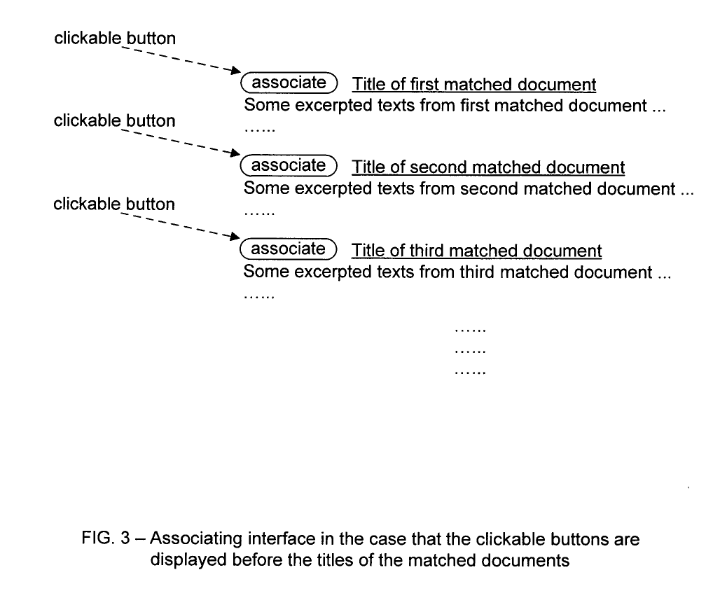

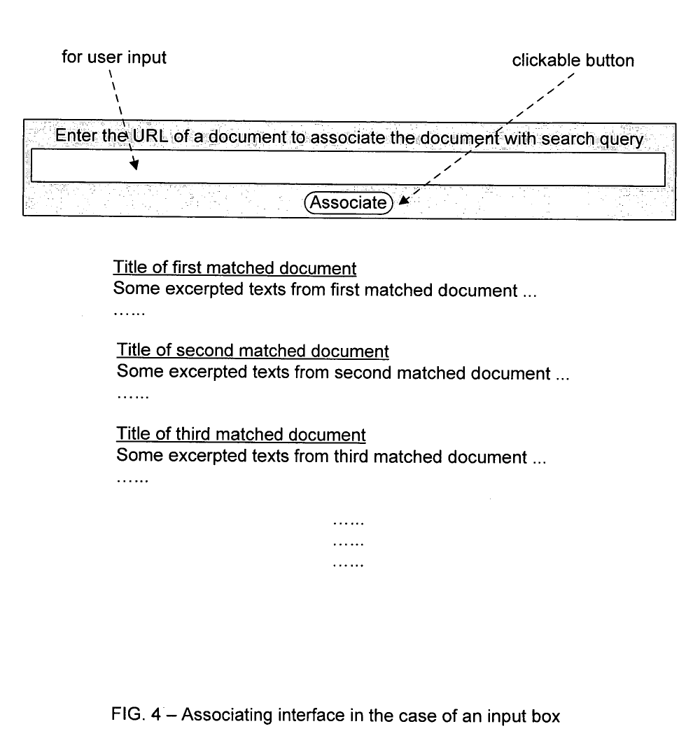

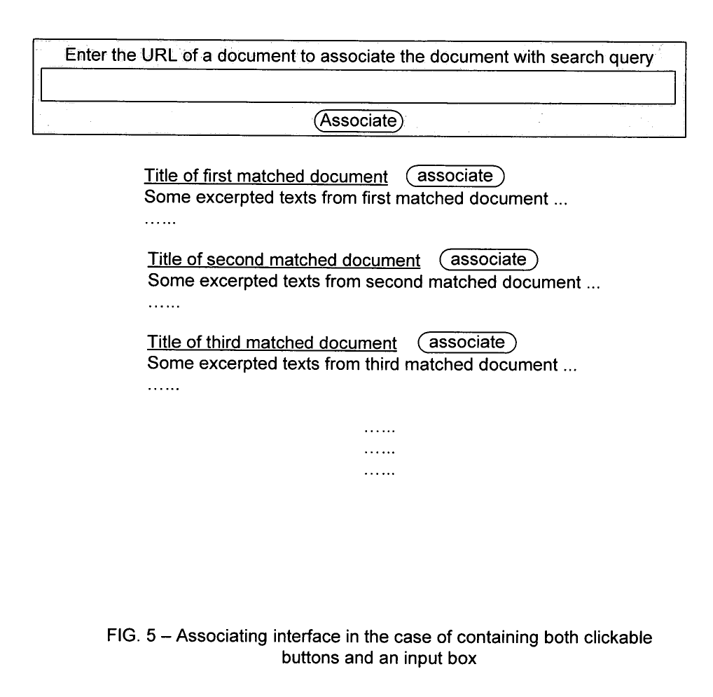

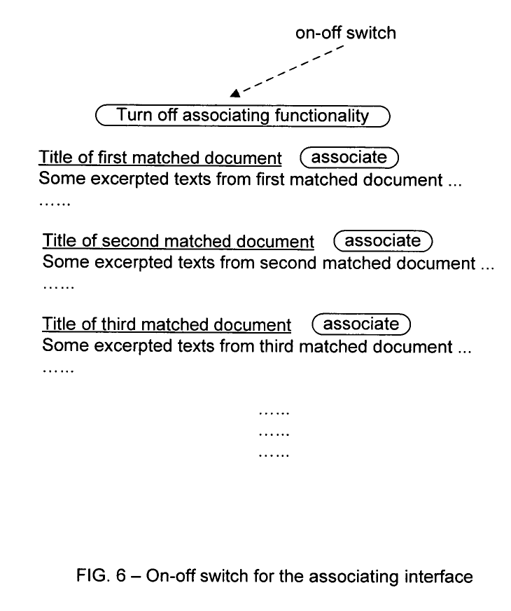

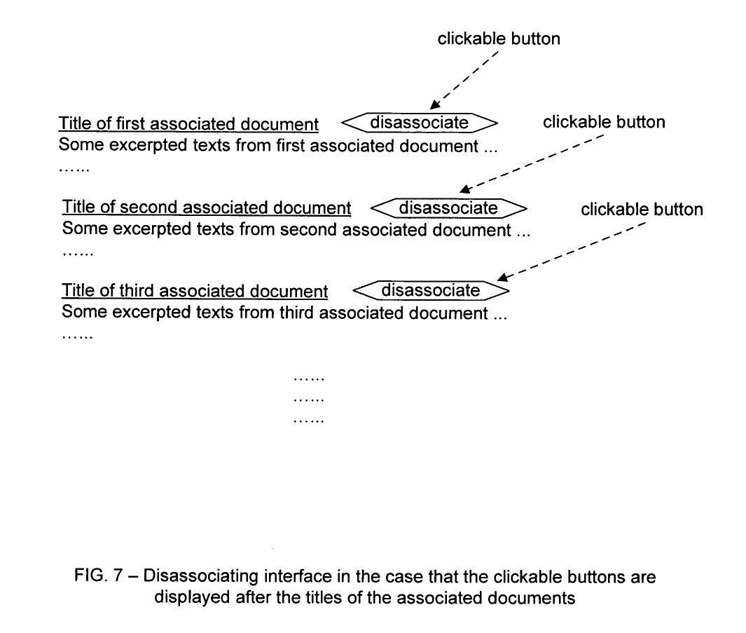

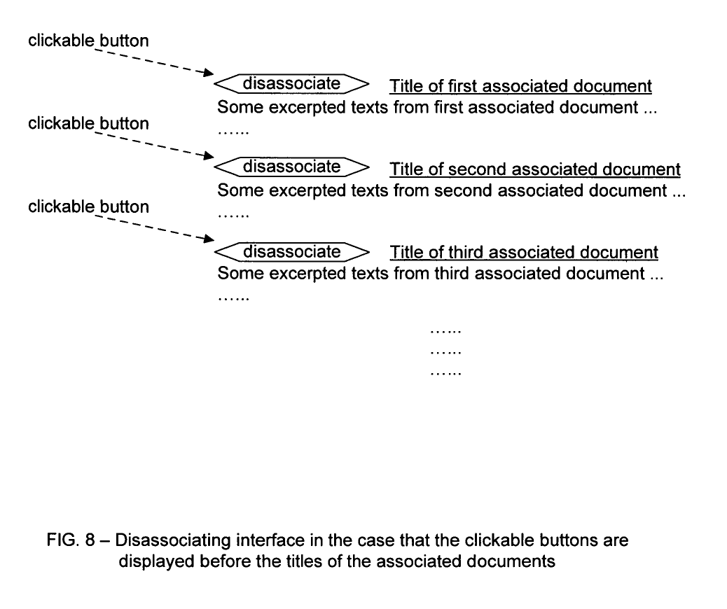

FIG. 2, FIG. 3, FIG. 4, FIG. 5, FIG. 6, FIG. 7 and FIG. 8 show various interfaces, including clickable buttons, input boxes and display of associated documents. The functionality of providing an interface is implemented through some programming language. The program code can be stored on a computer-readable storage medium. When executed, the program code will cause a computer to provide the interfaces.

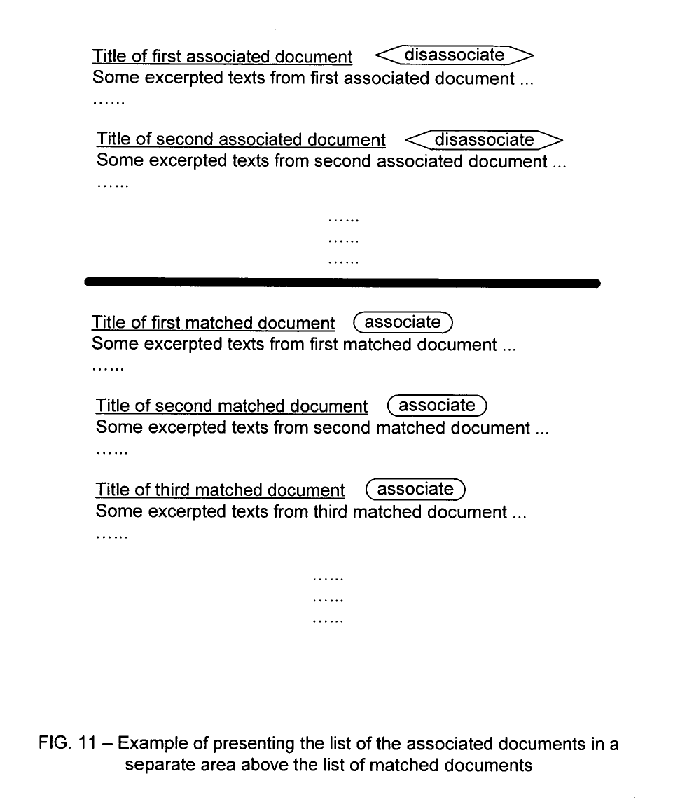

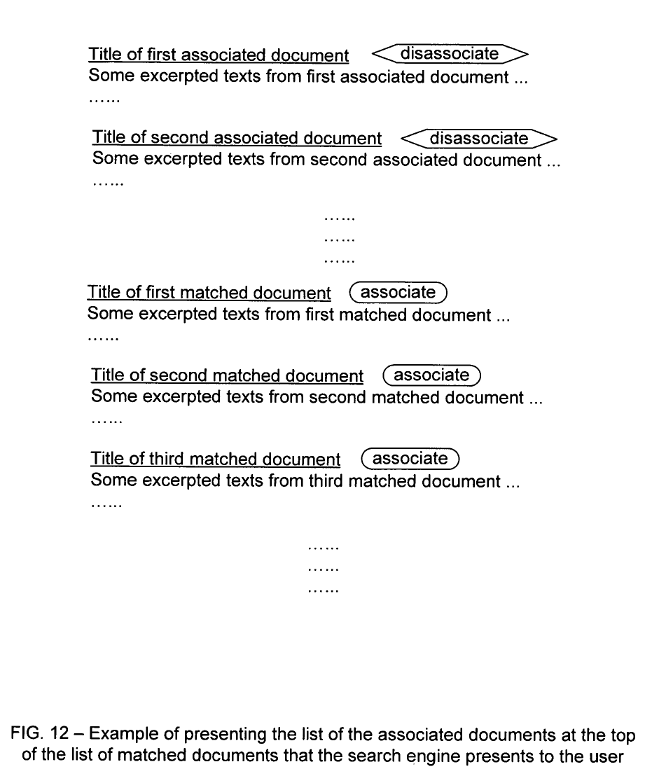

FIG. 11 and FIG. 12 show examples of presenting the associated documents to the user in a special area. The functionality of presenting the associated documents to the user in a special area is implemented through some programming language. The program code can be stored on a computer-readable storage medium. When executed, the program code will cause a computer to present the associated documents to the user in the special area.

### A. Preferred Embodiment

FIG. 1 shows a flow chart of the preferred embodiment.

Block (100) in FIG. 1 is providing an associating interface for a user of a query based search engine to associate documents with a search query, with the documents being termed as associated documents. In other words, the associating interface is an interface that the user can use to associate the documents with the search query. The term “associated documents” may contain only a single document when the user only associates one document with the search query. In this disclosure, the term “associated documents” should be interpreted in this way.

Whenever a user performs a search with a search query, when the search engine presents matched documents to the user, the step (100) will provide the associating interface to the user so that the user can use to associate documents with the search query.

An example of the associating interface is clickable buttons displayed with the titles of matched documents. This is the preferred way of implementing the associating interface. The user can click on the button with the title of a matched document to associate the document with the search query. The clickable buttons may be displayed after the titles or before the titles of the matched documents, or at other appropriate locations. It's preferred that the clickable buttons be displayed after the titles of the matched documents.

FIG. 2 shows the associating interface in the case that the clickable buttons are displayed after the titles of the matched documents. The matched documents are what the search engine presents to the user. The clickable buttons form the associating interface that the step (100) provides to the user. The user can click on a button after the title of a matched document to associate the document with the search query. Similarly, FIG. 3 shows the associating interface in the case that the clickable buttons are displayed before the titles of the matched documents.

The text in the clickable buttons in FIG. 2 and FIG. 3 can be something else, such as “associate with search query”, “associate this document with search query”, or similar things. It's preferred that the text is simple as long as the text can indicate to the user the functionality of the clickable buttons. The implementation of the step (100) may also choose not to provide any text at all with the clickable buttons.

Another example of the associating interface is an input box. The input box can be displayed above the top of the list of matched documents. The user can use the input box to enter an identifier of a document to associate the document with the search query, regardless of whether or not the document is a matched document. For an example, in the case of a web search engine, the user can enter the URL of a web page to associate the web page with the search query. FIG. 4 shows an example of such an input box. The user can enter the URL of a web page and then click on the “Associate” button to associate the web page with the search query.

A third example of the associating interface is providing both clickable buttons and an input box. The user can use either a clickable button or the input box to associate a document with the search query. FIG. 5 shows such an example.

An implementation of the present invention may provide an on-off switch for the associating interface. The on-off switch is an interface for the user to turn on and turn off the associating interface. In other words, the user can use the on-off switch to turn on or turn off the functionality of associating documents with the search query. The on-off switch may be implemented as a clickable button above the top of the list of matched documents. The user can click on the button to turn off the associating interface, and after the associating interface is turned off, the same clickable button can function as a turn on button that the user can click on to turn on the associating interface.

FIG. 6 shows an on-off switch for the associating interface. When the user clicks on the on-off switch button, all the “associate” clickable buttons will disappear, and the text in the on-off switch button will change to “Turn on associating functionality”. When the user clicks on the on-off switch button again, all the “associate” clickable buttons will appear again, and the text in the on-off switch button will change to “Turn off associating functionality” again.

An implementation of the present invention may set a maximum number of documents that the user can associate with the search query.

An implementation of the present invention may provide a disassociating interface for the user to disassociate an associated document from the search query, which is to remove the document from the list of associated documents for the search query.

An example of the disassociating interface is clickable buttons displayed with the titles of the associated documents. The user can click on the button with the title of an associated document to disassociate the document from the search query. The clickable buttons may be displayed after the titles or before the titles of the associated documents, or at other appropriate locations. It's preferred that the clickable buttons be placed after the titles of the associated documents.

FIG. 7 shows the disassociating interface in the case that the clickable buttons are displayed after the titles of the associated documents. The clickable buttons form the disassociating interface that the step (100) provides to the user. The user can click on a button after the title of an associated document to disassociate the document from the search query. Similarly, FIG. 8 shows the disassociating interface in the case that the clickable buttons are displayed before the titles of the associated documents.

The text in the clickable buttons in FIG. 7 and FIG. 8 can be something else, such as “disassociate from search query”, “disassociate this document from search query”, or similar things. It's preferred that the text is simple as long as the text can indicate to the user the functionality of the clickable buttons.

An implementation of the present invention may provide an on-off switch for the disassociating interface, just like an implementation of the present invention may provide an on-off switch for the associating interface described above. See the descriptions above for details of an on-off switch.

In this disclosure, when providing a clickable button for certain purposes, an implementation of the present invention may be place some texts in the button, around the button, or in other places or in other forms to notify the user of the functionality of the button. The implementation of the present invention may also choose not to provide any text at all with the clickable buttons.

Block (110) in FIG. 1 is storing the associated documents. The apparatus for storing the associated documents is termed as a document saver. The document saver stores the associated documents on a computer-readable storage medium.

The associated documents are user specific. For a same search query, the associated documents may be different for different users. The document saver can provide a user specific data set (or, data file), being termed as the user's “associated documents store”, for the following purposes: 1) storing all search queries with which the user have associated documents; 2) for each stored search query, storing all the search query's associated documents; and 3) for each stored associated document, storing all information about the associated document that the present invention will present to the user when presenting the associated document, with the information being termed as “display information” of the document. That is, in the associated documents store, each search query is linked with a list of associated documents, and each associated document is linked with the display information of the document.

There are various existing methods to identify a “user” of a search engine. For an example, a user may be identified by the IP address from which the search is performed. In this case, searches from a same IP address may be treated as being performed by a same user, and searches from different IP addresses may be treated as being performed by different users. For another example, a user may be identified by the username that the user registered through some mechanism.

The preferred way of storing an associated document in a user's associated documents store is storing an identifier of the document. For an example, when the search engine is a web search engine, then an identifier of the document can be the URL of the document.

As for the display information of an associated document that the document saver stores in the associated documents store, if the associated document was a matched document when the user associates the document with a search query, then the display information can be the information about the document that the search engine presents to the user. For an example, when the search engine is a web search engine, the display information is typically a title of the document which is a hyperlink of the document, some excerpted texts from the document, and something else. See FIG. 7 for an example of display information of an associated document.

If the associated document was not a matched document, then it implies that the user had entered an identifier of the document into an input box to associate the document with a search query. In this case, the display information of the document can simply be the identifier of the document.

When a user associates a document with a search query, the process that the document saver performs is shown in FIG. 9. The document saver first checks into the user's associated documents store to see whether the search query is already in the user's associated documents store. If the search query is not in the user's associated documents store, then the document saver adds the search query to the user's associated documents store and creates a list of associated documents for the search query which contains the document linked with display information of the document. If the search query is already in the user's associated documents store, the document saver checks whether the document is already in the list of associated documents of the search query. If the document is not already in the list of associated documents of the search query, then the document saver adds the document, linked with display information of the document, to the list of associated documents of the search query. If the document is already in the list of associated documents of the search query, then the document saver ends the process.

When a user disassociates a document from a search query, the process that the document saver performs is shown in FIG. 10. The document saver first removes the document from the list of associated documents of the search query in the user's associated documents store. If the removal of the document does not cause the list of associated documents of the search query to be empty, then the document saver ends the process. If the removal of the document causes the list of associated documents of the search query to be empty, which implies that there are no associated documents left for the search query, then the document saver removes the search query from the user's associated documents store.

Block (120) in FIG. 1 is causing the associated documents to be presented in a special area. The apparatus for causing the associated documents to be presented in a special area is termed as a presenter.

An example of the special area is a separate area above the list of matched documents that the search engine presents to the user. The separate area above the list of matched documents is the preferred place for the associated documents to be presented. FIG. 11 shows such an example of presentation of the associated documents. Another example of the special area is the top of the list of matched documents that the search engine presents to the user. FIG. 12 shows such an example of presentation of the associated documents.

Because the associated documents are presented in the special area, the user can easily sight the associated documents (that is, the user's desired documents).

An example of causing the associated documents to be presented in a special area is presenting the list of the associated documents in the special area. That is, the presenter presents the list of the associated documents in the special area.

Whenever the user performs a search with a search query and when the search engine presents matched documents to the user, the process that the presenter performs for presenting the list of the associated documents in the special area is shown in FIG. 13. The presenter first checks into the user's associated documents store to see whether the search query is in the user's associated documents store. If the search query is not in the user's associated documents store, the presenter ends the process. If the search query is in the user's associated documents store, the presenter retrieves display information of each associated document in the list of associated documents linked with the search query. Finally, the presenter presents the associated documents to the user in the special area. The presenter will present the display information of the associated documents plus the disassociating interface. See FIG. 11 for an example of the presentation of the associated documents.

When a user associates a document with a search query, after the document saver stores the associated document in the user's associated documents store, the process that the presenter performs is shown in FIG. 14. The presenter first retrieves display information of the associated document stored in the user's associated documents store. Then, the presenter checks whether the document is a matched document. If the document is not a matched document, the presenter adds the document to the list of associated documents presented in the special area by presenting the display information of the document plus a clickable button of the disassociating interface displayed with the title of the document. If the document is a matched document, the presenter removes the clickable button in the associating interface that is displayed with the title of the document, and then the presenter adds the document to the list of associated documents presented in the special area by presenting the display information of the document plus a clickable button of the disassociating interface displayed with the title of the document.

A simpler implementation of the process that the presenter performs when a user associates a document with a search query is simply first retrieving display information of the associated document and then adding the document to the list of associated documents presented in the special area. That is, the simpler implementation removes the steps (1410) and (1420) in FIG. 14, and goes directly from step (1400) to step (1430).

When a user disassociates a document from a search query, the process that the presenter performs is shown in FIG. 15. The presenter first removes the document from the list of associated documents presented in the special area. Then, the presenter checks whether the document is a matched document. If the document is not a matched document, then the presenter ends the process. If the document is a matched document, then presenter recovers the clickable button in the associating interface that is displayed with the title of the document.

A simpler implementation of the process that the presenter performs when a user disassociates a document from a search query is simply removing the document from the list of associated documents presented in the special area. That is, the simpler implementation only has the step (1500) in FIG. 15.

Another example of causing the associated documents to be presented in a special area is ranking the associated documents in a special way. The apparatus for ranking the associated documents in a special way is termed as a ranker.

One example of ranking the associated documents in a special way is assigning the highest rankings to the associated documents regardless of what rankings that the search engine would normally assign to the documents. Assigning the highest rankings to the associated documents causes the search engine to present the associated documents at the top of the list of matched documents that the search engine presents to the user.

Whenever a user performs a search with a search query, after the search engine identifies matched documents, and when the search engine ranks the matched documents, the process that the ranker performs is shown in FIG. 16. The ranker first checks into the user's associated documents store to see whether the search query is in the user's associated documents store. If the search query is not in the user's associated documents store, the ranker ends the process. If the search query is in the user's associated documents store, then the ranker assigns the highest possible rankings to the documents in the list of associated documents linked with the search query. To be specific, the ranker assigns to the first document in the list of associated documents the highest ranking that the search engine would possibly assign to a document; the ranker assigns to the second document in the list of associated documents the second highest ranking that the search engine would possibly assign to a document; the ranker assigns to the third document in the list of associated documents the third highest ranking that the search engine would possibly assign to a document; and so on and so forth.

### B. More Variations

It should be understood that the above descriptions of the preferred embodiment and the variations therein should not be construed as limiting the scope of the present invention. The descriptions should be appreciated by those skilled in the art that the conception and the specific embodiments disclosed may be readily utilized as a basis for modifying or designing other structures (including but not limited to various changes, substitutions and alterations) that do not depart from the spirit and scope of the present invention.

Below are more examples of possible modifications/variations. Again, the following examples of variations should not be construed as limiting the scope of the present invention.

(1) The presenter causing the associated documents to be presented in a special area may provide a mechanism for a user to change the order of the associated documents. For an example, the presenter may allow the user to move an associated document up and down in the list of the associated documents.

(2) If a user associates some documents with a search query, being termed as the original search query, then, when the same user performs a search with a similar search query, an implementation of the present invention can treat the similar search query as the same as the original search query and present the associated documents of the original search query in a special area or rank the associated documents in a special way when the user performs a search with the similar search query. For a search query, what search queries are “similar” search queries depends on how the implementer of the present invention sets the criteria. For an example, the implementer may treat the search queries “car”, “a car”, “automobile”, etc. as similar search queries.

(3) If a user, being termed as the original user, associates some documents with a search query, then, when a similar user performs a search with a same (or similar) search query, an implementation of the present invention can treat the similar user as the same as the original user and present the associated documents of the search query for the original user in a special area or rank the associated documents in a special way when the similar user performs a search with the same (or similar) search query. For a user, what users are “similar” users depends on how the implementer of the present invention sets the criteria. For an example, the implementer may treat all students in a class as “similar” users when they search for information about the class.

(4) An implementation of the present invention may create a default list of associated documents for a search query. When a user doesn't have associated documents for the search query that the user enters into the search engine, then the implementation of the present invention may present the default list of associated documents of the search query in a special area or rank the documents in the default list of associated documents of the search query in a special way.

What documents should be contained in the default list of associated documents for a search query depends on the implementation of the present invention. For an example, for a search query, the implementer of the present invention may choose to place in the default list of associated documents a certain number of documents (such as three, five, etc. documents) that most users associated with the search query. That is, if the number of users who associated a document with the search query is the largest number, then the document will be the first document in the default list of associated documents; if the number of users who associated a document with the search query is the second largest number, then the document will be the second document in the default list of associated documents; and so on and so forth.

### C. Conclusions, Ramifications and Scope of the Present Invention

(1) The present invention may be implemented as part of a search engine to enable a user of the search engine to have some control over the ranking and presentation of search results. The present invention may also be implemented as a separate product to enable a user of a search engine to have some control over the presentation of the search results. Furthermore, the present invention may be implemented as part of other types of products or implemented as a separate product to provide the invention's functionality to users of the other types of products.

(2) As already stated, it should be understood that using query based web search engines as an embodiment of query based search engines is for the sake of illustrations and explanations. It should not be construed as limiting the scope of the present invention. Those skilled in the art may apply the present invention to enable a user of any query based search engine to have some control over the ranking and presentation of search results.

For an example, a lot of software products (such as Microsoft Office products Word, Excel, PowerPoint, Outlook, etc.) have an accompanying help feature. The help feature usually contains a search functionality that a user can use to search help materials by entering a search query. The search functionality will return to the user a list of matched documents. The present invention can be implemented in the context of the search functionality.

For another example, an online store usually provides a search functionality for a user to search for desired products by entering a search query. The search functionality will return to the user a list of matched products. The present invention can be implemented in the context of the search functionality.

(3) As already stated, it should be understood that using Google as a representative of query based web search engines is for the sake of illustrations and explanations. It should not be construed as limiting the scope of the present invention. Those skilled in the art may apply the present invention to enable a user of any query based web search engine to have some control over the ranking and presentation of search results.

(4) The present invention not only can be used in query based search engines, generally, it can also be used in any situation in which a list of items is presented to users. The present invention enables users to have some control over the presentation of the items in the list. For an example, the presentation can be implemented for the user to set up so that the user's desired items will be presented in a special area that is easy to sight.

(5) It should be understood that the above descriptions (including but not limited to all the embodiments and their variations, and examples) are meant to be illustrative of the principles and various embodiments of the present invention. The above descriptions should not be construed as limiting the scope of the present invention. Numerous variations and modifications (including but not limited to various changes, adding similar parts or steps, taking off parts or steps, modifying parts or steps, substitutions and alterations) will become apparent to those skilled in the art once the above disclosure is fully appreciated, and such constructions do not depart from the spirit and scope of the present invention.

1. A computer-based method, comprising:
(1.a) providing an associating interface for a user of a query based search engine to associate documents with a search query, with the documents being termed as associated documents;
(1.b) storing the associated documents; and
(1.c) causing the associated documents to be presented in a special area.

2. The method of claim 1, wherein said providing an associating interface comprises providing clickable buttons displayed with the titles of matched documents.

3. The method of claim 1, wherein said providing an associating interface comprises providing an input box.

4. The method of claim 1, further comprising providing an on-off switch for the associating interface.

5. The method of claim 1, further comprising setting a maximum number of documents that the user can associate with the search query.

6. The method of claim 1, further comprising providing a disassociating interface for the user to disassociate an associated document from the search query.

7. The method of claim 6, wherein said providing a disassociating interface comprises providing clickable buttons displayed with the titles of the associated documents.

8. The method of claim 6, further comprising providing an on-off switch for the disassociating interface.

9. The method of claim 1, wherein said storing the associated documents comprises providing an associated documents store for storing the associated documents.

10. The method of claim 1, wherein said causing the associated documents to be presented in a special area comprises causing the associated documents to be presented in a separate area above the list of matched documents that the search engine presents to the user.

11. The method of claim 1, wherein said causing the associated documents to be presented in a special area comprises causing the associated documents to be presented at the top of the list of matched documents that the search engine presents to the user.

12. The method of claim 1, wherein said causing the associated documents to be presented in a special area comprises presenting the list of the associated documents in the special area.

13. The method of claim 1, wherein said causing the associated documents to be presented in a special area comprises ranking the associated documents in a special way.

14. A system, comprising:
(14.a) an associating interface for a user of a query based search engine to associate documents with a search query, with the documents being termed as associated documents;
(14.b) a document saver for storing the associated documents; and
(14.c) a presenter for causing the associated documents to be presented in a special area.

15. The system of claim 14, wherein said associating interface comprises clickable buttons displayed with the titles of matched documents.

16. The system of claim 14, wherein said associating interface comprises an input box.

17. The system of claim 14, further comprising an on-off switch for the associating interface.

18. The system of claim 14, further comprising a disassociating interface for the user to disassociate an associated document from the search query.

19. The system of claim 18, wherein said disassociating interface comprises clickable buttons displayed with the titles of the associated documents.

20. The system of claim 18, further comprising an on-off switch for the disassociating interface.

21. The system of claim 14, wherein said document saver comprises an associated documents store for storing the associated documents.

22. The system of claim 14, wherein said special area comprises a separate area above the list of matched documents that the search engine presents to the user.

23. The system of claim 14, wherein said special area comprises the top of the list of matched documents that the search engine presents to the user.

24. A computer-readable storage medium storing program code for causing a computer to perform the steps of:
(24.a) providing an associating interface for a user of a query based search engine to associate documents with a search query, with the documents being termed as associated documents;
(24.b) storing the associated documents; and
(24.c) causing the associated documents to be presented in a special area.

25. A computer-readable storage medium storing program code for causing a computer to provide an associating interface for a user of a query based search engine to associate documents with a search query.
